(19) United States
(12) Patent Application Publication
(10) Pub. No.: US 2026/0162985 A1
(43) Pub. Date: Jun. 11, 2026

(54) LITHIUM-SULFUR BATTERY POSITIVE ELECTRODE MATERIAL, MANUFACTURING METHOD, AND LITHIUM-SULFUR SECONDARY BATTERY USING THE SAME

(71) Applicant: POSTECH RESEARCH AND BUSINESS DEVELOPMENT FOUNDATION, Pohang-si (KR)

(72) Inventors: Won Bae KIM, Pohang-si (KR); Junhyuk JI, Pohang-si (KR)

(21) Appl. No.: 19/179,060

(22) Filed: Apr. 15, 2025

(30) Foreign Application Priority Data
May 30, 2024 (KR) 10-2024-0070810
Aug. 20, 2024 (KR) 10-2024-0111215

(51) Int. Cl. H01M 4/58; H01M 4/02; H01M 4/04; H01M 4/136; H01M 4/1397; H01M 4/62; H01M 10/0525

(52) U.S. Cl. CPC H01M 4/5815; H01M 4/0471; H01M 4/136; H01M 4/1397; H01M 4/625; H01M 10/0525; H01M 2004/028

(57) ABSTRACT

An object of the invention is to provide a lithium-sulfur battery positive electrode material that makes it possible to prevent a shuttle effect that may occur during cycling in a lithium-sulfur battery and the deterioration of the lifespan due to a large volume change of the positive electrode, and a manufacturing method for the lithium-sulfur battery positive electrode. To achieve such an object as described above, a lithium-sulfur battery positive electrode material according to the invention includes a nitrogen-doped carbon nanotube and sulfur arranged in an inside of the carbon nanotube, in which transition metal sulfide nanocrystals are dispersed on a surface of the carbon nanotube.

### BACKGROUND OF THE INVENTION

### 1. Field of the Invention

The present invention relates to a lithium-sulfur battery positive electrode material containing sulfur in an inside of a nitrogen-doped carbon nanotube and particularly relates to a lithium-sulfur battery positive electrode material characterized in that nanocrystals of a nickel and cobalt sulfide are dispersed and arranged on a surface of the nitrogen-doped carbon nanotube, and a manufacturing method for the same.

### 2. Description of the Related Art

A lithium-sulfur battery has attracted great interest due to having a very high energy storage density (about 2, 600 Wh/kg) by using naturally abundant and inexpensive sulfur as a positive electrode. However, the actual application of the lithium-sulfur battery is difficult due to several technical issues such as the low electrical conductivity of sulfur and discharge products (for example, Li₂S₂ and Li₂S), the shuttle effect of lithium polysulfide in an electrolyte, and volume expansion of the electrode.

Recently, various strategies have been proposed and attempted to improve the reaction rate of oxidation-reduction in the positive electrode reaction and maximize the utilization of sulfur, most of which have focused on novel designs and applications of a host positive electrode, a functional separation membrane/interlayer, an electrolyte formulation, a binder, a selenium/tellurium-sulfur composite, and the like.

On the other hand, there is research on a technology to efficiently develop sulfur electrochemistry by adsorbing a general transition metal (TM) compound in a form of a nitride, an oxide, a chalcogenide, a carbide, or a phosphide to a carbon-based host substance, where it is reported that the immobilization properties of polysulfides are improved on the surface and the corrosion resistance of catalytic substances may be improved. However, specific development of sulfide catalysts has not yet been achieved.

### SUMMARY OF THE INVENTION

An object of the invention is to provide a lithium-sulfur battery positive electrode material that makes it possible to prevent the shuttle effect that may occur during cycling in a lithium-sulfur battery and deterioration of the lifespan due to a large volume change of the positive electrode, and a manufacturing method for the lithium-sulfur battery positive electrode.

In addition, another object of the invention is to provide a lithium-sulfur battery excellent in lifespan characteristics due to having a small shuttle effect and a small volume change.

To achieve such objects as described above, an embodiment of the invention provides a lithium-sulfur battery positive electrode material including a nitrogen-doped carbon nanotube and sulfur arranged in an inside of the carbon nanotube, in which transition metal sulfide nanocrystals are dispersed on a surface of the carbon nanotube.

In addition, according to an embodiment of the lithium-sulfur battery positive electrode material according to the invention, the transition metal in the transition metal sulfide nanocrystals may be nickel and cobalt.

In addition, according to an embodiment of the lithium-sulfur battery positive electrode material according to the invention, the transition metal sulfide nanocrystal may have a composition according to the following [Chemical Formula 1].

NiₓCO₁₋ₓS₂ (0.1≤x≤0.7) [Chemical Formula 1]

In addition, according to an embodiment an embodiment of the lithium-sulfur battery positive electrode material according to the invention, the x may be in a range of 0.2≤x≤0.5.

On the other hand, an embodiment of the invention provides a manufacturing method for a lithium-sulfur battery positive electrode material according to the invention, which may include preparing a nitrogen-doped carbon nanotube, synthesizing a nickel-thiourea compound and a cobalt-thiourea compound, adding the nitrogen-doped carbon nanotube to a solvent and dispersing the nitrogen-doped carbon nanotube, adding the nickel-thiourea compound and the cobalt-thiourea compound to the solvent in which the carbon nanotube is dispersed and carrying out mixing to prepare a mixed slurry, evaporating the solvent while stirring the mixed slurry, to thereby obtain a solid mixture, heating the solid mixture to obtain a transition metal sulfide-carbon nanotube composite in which the transition metal sulfide nanocrystal is dispersed and arranged on a surface of the nitrogen-doped carbon nanotube, and injecting sulfur into an inside of the transition metal sulfide-carbon nanotube composite.

According to an embodiment of the manufacturing method for a lithium-sulfur battery positive electrode material according to the invention, the preparing of the nitrogen-doped carbon nanotube may include (a) adding FeCl₃ and sodium dodecylbenzenesulfonate (SDBS) to a methyl orange aqueous solution and carrying out mixing to prepare a mixed aqueous solution, (b) adding pyrrole dropwise while stirring the mixed aqueous solution, (c) recovering a precipitate from the mixed aqueous solution to which the pyrrole is added dropwise, and (d) heating the precipitate to obtain the nitrogen-doped carbon nanotube.

In addition, according to an embodiment of the manufacturing method for a lithium-sulfur battery positive electrode material according to the invention, the heating of the solid mixture may be maintained in a range of 300° C. to 500° C. in an inert gas atmosphere.

On the other hand, it is possible to provide, according to the invention, a lithium-sulfur battery containing the above-described lithium-sulfur battery positive electrode material according to the invention.

### BRIEF DESCRIPTION OF THE DRAWINGS

FIG. 1 is a conceptual view describing a manufacturing method for a lithium-sulfur battery positive electrode material according to an embodiment of the invention;

FIG. 2 shows the morphology analysis results of a Ni_{0.261}Co_{0.739}S₂@NPCTs host substance according to an embodiment of the invention;

FIG. 3A, FIG. 3B and FIG. 3C show the XRD analysis results of a NiₓCo₁₋ₓS₂@NPCTs host substance according to an embodiment of the invention;

FIG. 4A and FIG. 4B show the thermal analysis results of NiₓCo₁₋ₓS₂@NPCTs/S according to an embodiment of the invention in air and in an argon atmosphere;

FIG. 5A and FIG. 5B show graphs showing the results obtained by evaluating capacity and cycle performance according to a charging and discharging rate of a cell that uses a positive electrode material according to an embodiment of the invention;

FIG. 6 shows graphs showing a constant current charging and discharging profile of a cell that uses a positive electrode material according to an embodiment of the invention;

FIG. 7A and FIG. 7B show graphs showing a high-rate charging and discharging cycle of a cell that uses a positive electrode material according to an embodiment of the invention and a charging and discharging cycle according to a loading amount of sulfur; and

FIG. 8A, FIG. 8B and FIG. 8C show graphs showing the results obtained by analyzing an electrochemical impedance spectroscopy Nyquist plot of a cell that uses a positive electrode material according to an embodiment of the invention.

### DETAILED DESCRIPTION OF THE EXEMPLARY EMBODIMENTS

Hereinafter, with reference to the attached drawings, embodiments of the present application will be described in detail so that a person skilled in the art may easily carry out the embodiments of the present application. However, the present application may be embodied in various forms different from each other and thus is not limited to the embodiments described herein.

In addition, in order to clearly describe the present application in the drawings, portions unrelated to the description have been omitted, and similar reference numerals for drawings have been attached to similar portions throughout the specification.

Throughout the specification of the present application, in a case where a certain part is said to “include” a certain component, it means that other components may be further included rather than excluding other components, unless the context specifically states otherwise.

Terms such as “about” and “substantially” which are used in the present specification are used to mean to be at the numerical value or close to the numerical value in a case where allowable errors for intrinsic manufacturing and intrinsic substances are provided for the mentioned meaning, and they are used to prevent an unscrupulous infringer from unfairly utilizing the disclosed content in which accurate or absolute numerical values are mentioned to aid the understanding of the present application. In addition, throughout the specification of the present application, the term “step of ˜ing” or “step of ˜” does not mean “step for ˜.”

Throughout the specification of the present application, the term “a combination thereof” included in the Markush form means a mixture or combination of one or more selected from the group consisting of components, which is described in the Markush form expression, and it is used to mean that one or more selected from the group consisting of the components are included.

Throughout the specification of the present application, the description “A and/or B” means “A or B, or A and B”.

In addition, unless defined otherwise, all technical and scientific terms have the same meanings as the meanings that are commonly understood by one among the people skilled in the art to which the invention pertains. The terms used for the description in the present application are intended only to effectively describe the specific examples and are not intended to limit the invention. In addition, a unit of a compound, which is not specifically described in the specification, may be % by weight.

A lithium-sulfur battery positive electrode material according to the invention includes a nitrogen-doped carbon nanotube and sulfur arranged in an inside of the carbon nanotube, and it may be a composite having a structure in which transition metal sulfide nanocrystals are dispersed on the surface of the carbon nanotube.

The lithium-sulfur battery uses sulfur as the positive electrode material and uses metallic lithium as the negative electrode material. In a charged state, the lithium-sulfur battery maintains a state of sulfur and metallic lithium. Then, during discharging, sulfur in the positive electrode reacts with lithium in the negative electrode and is ultimately converted into Li₂S which is a lithium sulfur compound, while a proportion of lithium gradually increases. In this case, it is important to effectively control lithium polysulfides (Li₂S₈, Li₂S₆, Li₂S₄, and the like) which are intermediate products. These lithium polysulfides are likely to dissolve into an electrolyte, which results in a shuttle effect that reduces energy density as the cycle progresses.

To prevent such a shuttle effect, sulfur is arranged in the inside of the carbon nanotube, whereby excellent cycle characteristics are exhibited as compared with a case where sulfur alone is used as the positive electrode. However, there is still such a limitation that the prevention of the shuttle effect is not satisfactory.

In order to solve such a limitation, the invention is characterized in that a nitrogen-doped carbon nanotube is used and transition metal sulfide nanocrystals are adsorbed on the surface of the nitrogen-doped carbon nanotube to improve the catalytic effect.

Since the nitrogen-doped carbon nanotube has high electrical conductivity and high chemical activity, it is possible to improve catalytic properties. In addition to this, the transition metal sulfide nanocrystal has relatively high electrical conductivity and effective binding sites for 1 polysulfides (LiPSs) on the catalyst surface, and thus it is possible to suppress the shuttle effect. Due to having much higher electrical conductivity than a transition metal oxide or nitride, this transition metal sulfide nanocrystal, particularly NiS₂ or CoS₂ accelerates the reaction of oxidation-reduction of lithium polysulfides, thereby being effective in suppressing the shuttle effect. In particular, Coₒₕ²⁺ may strongly interact with LiPSs through a Co—S bond by strongly adsorbing LiPSs to vacant sites, thereby suppressing the shuttle effect.

On the other hand, CoS₂ exhibits an excellent capacity under conditions of charging and discharging at a row rate due to the too strong bonding to LiPSs; however, in a case of charging and discharging at a high rate, it is difficult for the reactants to dissociate from the catalyst surface, which results in a deterioration of performance.

To overcome this, in an embodiment of the invention, the transition metal sulfide nanocrystal may be a sulfide nanocrystal containing both nickel and cobalt.

Niₒₕ²⁺ appropriately lowers the too strong binding energy between CoS₂ and LiPSs to induce a sustainable cooperative catalytic action, which makes it possible to control the formation of a 2D-shape Li₂S film on the catalyst surface. As a result, it is possible to synthesize a catalyst having an appropriate adsorption energy that is favorable for a reaction through a sulfide containing both nickel and cobalt.

To this end, in an embodiment of the invention, the transition metal sulfide nanocrystal may have a composition according to the following [Chemical Formula 1].

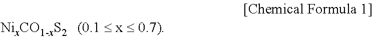

By properly controlling the bonding force to LiPSs through the appropriate ratio of nickel and cobalt, the lithium-sulfur battery reaction may be optimized. To this end, it is desirable that the value of x in the transition metal sulfide represented by NiₓCo₁₋ₓS₂ is 0.1 or more and 0.7 or less. This is because in a case where the value of Ni is too small, the strong bonding force of Co may not be lowered, and in a case where the value of Ni is too large, it is difficult to effectively suppress the shuttle effect. It is more desirable that the value of x may be 0.2 or more and 0.5 or less.

In addition, according to the invention, a lithium-sulfur battery containing the above-described lithium-sulfur battery positive electrode material may be provided. A lithium-sulfur secondary battery including the positive electrode material according to the invention may improve lifespan characteristics by suppressing the shuttle effect in the related art.

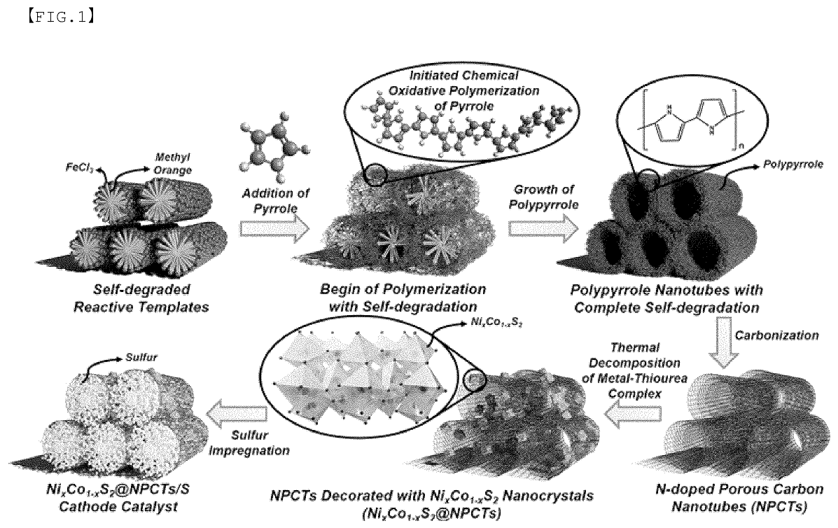

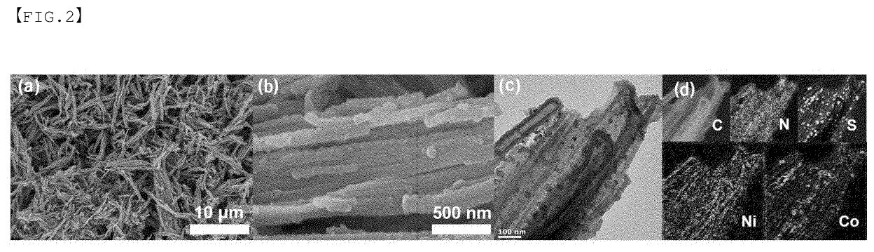

On the other hand, in order to manufacture such a lithium-sulfur battery positive electrode material, an embodiment of the invention may include preparing a nitrogen-doped carbon nanotube, synthesizing a nickel-thiourea compound and a cobalt-thiourea compound, adding the nitrogen-doped carbon nanotube to a solvent and dispersing the nitrogen-doped carbon nanotube, adding the nickel-thiourea compound and the cobalt-thiourea compound to the solvent in which the carbon nanotube is dispersed and carrying out mixing to prepare a mixed slurry, evaporating the solvent while stirring the mixed slurry, thereby obtaining a solid mixture, heating the solid mixture to obtain a transition metal sulfide-carbon nanotube composite in which the transition metal sulfide nanocrystal is dispersed and arranged on a surface of the nitrogen-doped carbon nanotube, and injecting sulfur into an inside of the transition metal sulfide-carbon nanotube composite. Such a manufacturing method for a positive electrode material is illustrated in detail in FIG. 1.

In order to disperse and arrange nitrogen-doped carbon nanotubes on the surfaces of carbon nanotubes of the transition metal sulfide after preparing the nitrogen-doped carbon nanotubes, a metal nitrate was not used in the invention; however, instead, a nickel-thiourea compound and a cobalt-thiourea compound were synthesized by utilizing thiourea containing sulfur and used. By synthesizing and using a thiourea compound in this way, it is favorable for producing sulfide crystals, and the crystal size may be controlled at a nano-sized scale.

By mixing a thiourea compound and carbon nanotubes in a solvent to make a mixed slurry, subsequently evaporating the solvent to obtain a solid mixture, and then carrying out a heat treatment, it is possible to obtain carbon nanotubes having nano-sized nickel-cobalt sulfides that are uniformly dispersed on the surface of the carbon nanotubes. For crystallization of the sulfide, it is desirable that the heat treatment of the solid mixture is maintained in an inert gas atmosphere in a range of 300° C. to 500° C. for 1 hour or more.

By heating sulfur and injecting the sulfur into the inside of the obtained transition metal sulfide-carbon nanotube composite, it is possible to manufacture a final lithium-sulfur battery positive electrode material.

On the other hand, the preparing of the nitrogen-doped carbon nanotube may include (a) adding FeCl₃ and sodium dodecylbenzenesulfonate (SDBS) to a methyl orange aqueous solution and carrying out mixing to prepare a mixed aqueous solution, (b) adding pyrrole dropwise while stirring the mixed aqueous solution, (c) recovering a precipitate from the mixed aqueous solution to which the pyrrole is added dropwise, and (d) heating the precipitate to obtain the nitrogen-doped carbon nanotube.

In a case where a solution containing a large number of templates having a nanotube shape is produced by utilizing a reaction between methyl orange and FeCl₃, and then pyrrole, which is a carbon source and a monomer, is added into the solution, and stirring is carried out, the added pyrrole undergoes a polymer polymerization reaction mediated by FeCl₃, and polypyrrole nanotubes are synthesized depending on the shape of the template. During this process, the template undergoes degradation and disappears.

By carbonizing these polypyrrole nanotubes, nitrogen-doped carbon nanotubes may be prepared.

Hereinafter, an example of the lithium-sulfur battery positive electrode material according to the invention and the results of the characteristic evaluation thereof are described.

### EXAMPLE 1

### Synthesis of NiₓCo₁₋ₓS₂-containing host material

First, 0.0818 g of methyl orange was dissolved in 50 ml of distilled water, and then FeCl₃ (0.406 g) and SDBS (0.0176 g) were sequentially added thereto while stirring. After 2 hours, 170 μl of pyrrole was slowly added dropwise while carrying out stirring continuously overnight. A black precipitate obtained through this process was washed and dried. To manufacture nitrogen-doped porous carbon nanotubes (NPCT) having a desired shape, the powder was subjected to a heat treatment at 650° C. for 5 hours in an argon atmosphere. Then, 1.163 g of nickel nitrate hexahydrate was dissolved in 20 mL of 1-butanol while carrying out vigorous stirring at 80° C., and then 1.216 g of thiourea was added thereto to obtain a nickel-thiourea composite (Ni(TU)₄(NO₃)₂). Secondly, a cobalt-thiourea composite (Co(TU)₄(NO₃)₂) was synthesized through the same method except that 1.164 g of cobalt nitrate hexahydrate was used in place of the nickel precursor. The obtained solid product was washed and dried. Then, 0.10 g of NPCT was well dispersed in 15 mL of acetone by a sonication treatment, and the nickel-thiourea composite (20 mg) and the cobalt-thiourea composite (30 mg) were added thereto. A mixture obtained in advance was evaporated with stirring at 35° C. and baked at 400° C. for 2 hours in an argon atmosphere. Finally, NPCT (denoted as Ni_{0.261}Co_{0.739}S₂@NPCTs) to which the nickel-cobalt sulfide nanocrystals were adsorbed was obtained.

(Manufacturing of NiₓCO₁₋ₓS₂@NPCTs/S Positive Electrode Material)

In order to add sulfur into the inside of the Ni_{0.261}Co_{0.739}S₂@NPCTs host substance, elemental sulfur (63.6% by weight) and the Ni_{0.261}Co_{0.739}S₂@NPCTs host substance (36.4% by weight) were mixed and then heated at 155° C. for 12 hours to manufacture a lithium-sulfur battery positive electrode material.

### (Manufacturing of Lithium-Sulfur Battery)

The manufactured positive electrode material (75% by weight) was mixed with MWCNT (15% by weight) and poly(vinylidene fluoride-co-hexafluoro-propylene) (PVDF-HFP) binder (10% by weight) in 1-methyl-2-pyrrolidinone (NMP), and then the mixture was cast on a carbon-coated aluminum foil and dried overnight at 60° C. in a vacuum to manufacture a positive electrode. A CR2032 type coin cell was manufactured with the manufactured positive electrode, the assembly was carried out in a glove box filled with argon, and the test was carried out in a battery system (WBCS 3000; Won-A Tech) maintained at 25° C. The electrolyte was a 1.0 M lithium bis(trifluoromethanesulfonyl)imide (LiTFSI) solution obtained by adding 2% by weight of LiNO₃ as an additive in DOL/DME (v/v=1:1). The E/S ratio was set to 30 μL/mg. In a case of the constant current charging and discharging, the voltage range was controlled in a range of 1.7 V to 2.8 V (vs. Li/Li+). CV was carried out at several scanning speeds under the same voltage range in a range of 0.03 to 0.20 mV/s.

### (Substance Evaluation)

For the morphology observation, the observation was carried out by using SEM (JSM-7800F Prime; JEOL) using EDS at 5.0 kV and TEM (JEM-2200FS; JEOL) using EELS at 200 kV

The crystal structure was checked by XRD (Ultima IV; Rigaku) using a Cu-Kα radiation (Δ=1.5418 Å) source having a Ni filter at 40 kV and 30 mA, and SAED (JEM-2200FS; JEOL) was also applied for the same purpose.

XPS (K-Alpha+; Thermo Fisher Scientific) analysis was carried out with a monochromatic Al-Kα source (E=1486.6 ev). Thermal decomposition data were obtained using a thermogravimetric analyzer (TGA, SDT Q600; TA instruments).

A BET method (ASAP 2020 BET/porosimeter; Micromeritics) using N2 adsorption-desorption was applied to measure the surface area.

The metal concentration of the catalyst was measured by ICP-AES (ICAP 6000; Thermo Fisher Scientific). A Rietveld structural analysis was carried out using a synchrotron high-resolution XRD pattern obtained at a beamline 9B HRPD of the Pohang Synchrotron Radiation Source (PLS-II), and the wavelength of the monochromatic X-ray was 1.5309 Å. An ex-situ SAXS experiment was carried out at a 6D C&S UNIST SAXS beamline of PLS-II at a wavelength of 1.07216 Å and an X-ray energy of 11.564 keV. The powder and electrode K-edge X-ray absorption fine structure (XAFS) data were collected at a 7D XAFS and a 10C Wide-XAFS beam lines of PLS-II in a transmission and fluorescence mode.

### EXAMPLE 2

### Synthesis of NiS₂@NPCTs Host Material

The synthesis procedure for Ni₂@NPCTs was similar to the synthesis procedure for Ni_{0.261}Co_{0.739}S₂@NPCTs; however, during the production process, 50 mg of the nickel-thiourea composite was added to a NPCTs dispersion mixture not having a cobalt-thiourea composite.

The rest, that is, the manufacturing of the positive electrode material and the manufacturing and evaluation of the cell were carried out in the same manner as in Example 1.

### EXAMPLE 3

### Synthesis of Ni_{0.679}Co_{0.321}S₂@NPCTs Host Material

The synthesis procedure was similar to the synthesis procedure for Ni_{0.261}Co_{0.739}S₂@NPCTs; however, during the production process, 40 mg of the nickel-thiourea composite and 10 mg of the cobalt-thiourea composite were added to the NPCTs dispersion mixture.

The rest, that is, the manufacturing of the positive electrode material and the manufacturing and evaluation of the cell were carried out in the same manner as in Example 1.

### EXAMPLE 4

### Synthesis of Ni_{0.444}Co_{0.556}S₂@NPCTs Host Material

The synthesis procedure was similar to the synthesis procedure for Ni_{0.261}Co_{0.739}S₂@NPCTs; however, during the production process, 30 mg of the nickel-thiourea composite and 20 mg of the cobalt-thiourea composite were added to the NPCTs dispersion mixture.

The rest, that is, the manufacturing of the positive electrode material and the manufacturing and evaluation of the cell were carried out in the same manner as in Example 1.

### EXAMPLE 5

### Synthesis of Ni_{0.135}Co_{0.865}S₂@NPCTs Host Material

The synthesis procedure was similar to the synthesis procedure for Ni_{0.261}Co_{0.739}S₂@NPCTs; however, during the production process, 10 mg of the nickel-thiourea composite and 40 mg of the cobalt-thiourea composite were added to the NPCTs dispersion mixture.

The rest, that is, the manufacturing of the positive electrode material and the manufacturing and evaluation of the cell were carried out in the same manner as in Example 1.

### EXAMPLE 6

### Synthesis of CoS₂@NPCTs Host Substance

The synthesis procedure was similar to the synthesis procedure for Ni_{0.261}Co_{0.739}S₂@NPCTs; however, during the manufacturing process, 50 mg of the cobalt-thiourea composite was added to the NPCTs dispersion mixture without a nickel-thiourea composite.

The rest, that is, the manufacturing of the positive electrode material and the manufacturing and evaluation of the cell were carried out in the same manner as in Example 1.

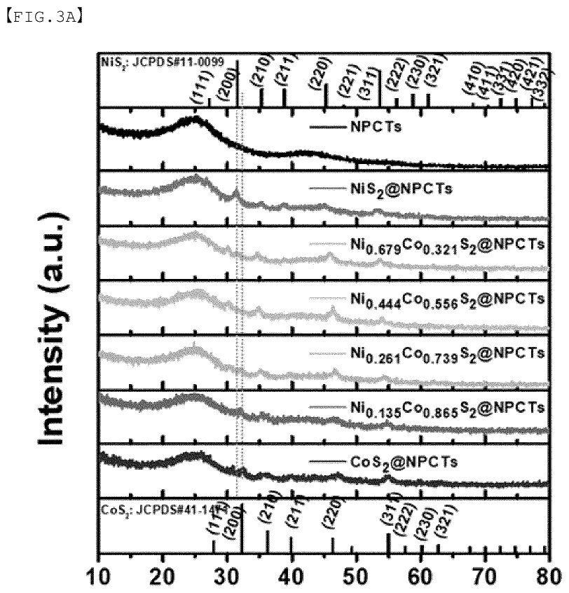

FIG. 2 shows the results of the analysis of SEM and TEM of the Ni_{0.261}Co_{0.739}S₂@NPCTs host substance manufactured according to Example 1. The results show that a nickel-cobalt sulfide is uniformly dispersed on the surface of the nanotube.

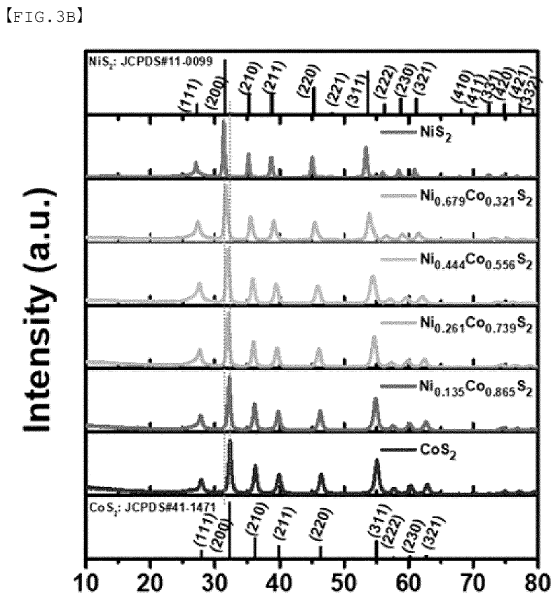

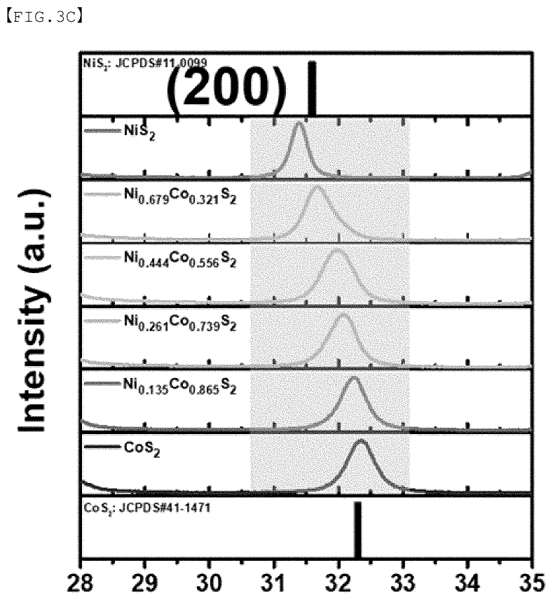

FIG. 3A, FIG. 3B and FIG. 3C show the results obtained by analyzing the XRD of the manufactured NiₓCo₁₋ₓS₂@NPCTs host substance. FIG. 3A shows the results obtained by analyzing the complexed host substance, and FIG. 3B and FIG. 3C show the results obtained by analyzing only the sulfide without carbon nanotubes. The sulfide showed diffraction peaks consistent with NiS₂ and CoS₂. In particular, the main peak around 2θ of 31° to 32°, indexed on the (200) plane of NiₓCo₁₋ₓS₂, gradually shifted to a higher diffraction angle as the cobalt ratio increased (FIG. 3C). Through this, the lattice constant value and the interplanar distance (d₍₂₀₀₎) of the sulfide crystals could be obtained as shown in Table 1 below. Such a change in crystal structure makes it possible to control the bonding force between the host substance and sulfur.

TABLE 1

| Specimen | 2θ (°) | Lattice constant (Å) | d₂₀₀ (Å) |
|---|---|---|---|
| NiS₂ | 31.38 | 5.70 | 2.85 |
| Ni_{0.679}Co_{0.321}S₂ | 31.68 | 5.64 | 2.82 |
| Ni_{0.444}Co_{0.556}S₂ | 31.98 | 5.59 | 2.80 |
| Ni_{0.261}Co_{0.739}S₂ | 32.08 | 5.58 | 2.79 |
| Ni_{0.135}Co_{0.865}S₂ | 32.24 | 5.55 | 2.78 |
| CoS₂ | 32.36 | 5.53 | 2.76 |

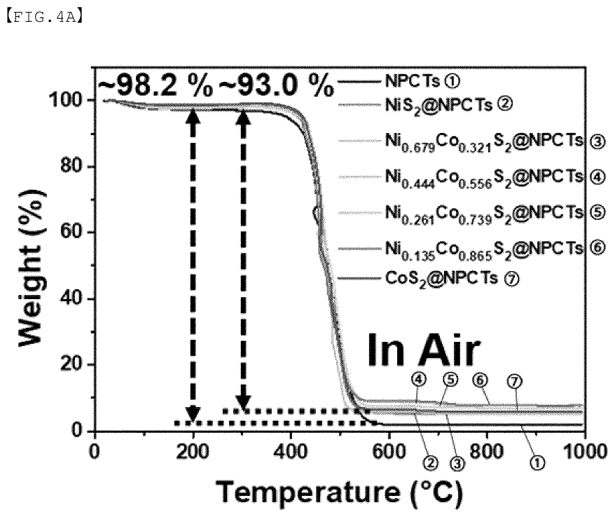

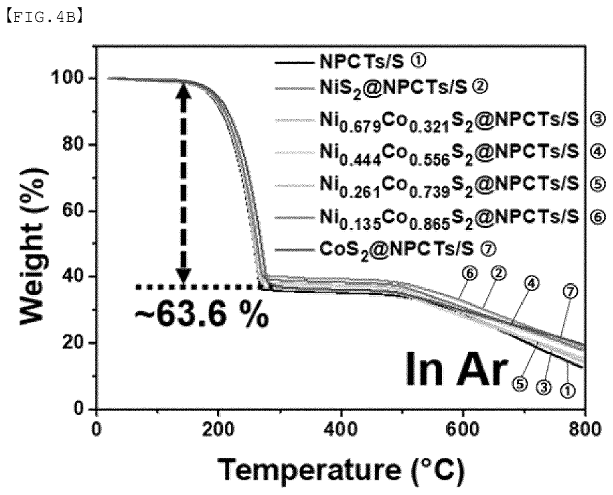

FIG. 4A and FIG. 4B show the results of the thermal analysis (TGA) of NiₓCo₁₋ₓS₂@NPCTs/S in air and in an argon atmosphere. According to the TGA analysis, the positive electrode system of NiₓCo₁₋ₓS₂@NPCTs/S turned out to be composed of each of about 1.9% by weight of a NiₓCo₁₋ₓS₂ substance, 34.5% by weight of NPCT, and 63.6% by weight of sulfur.

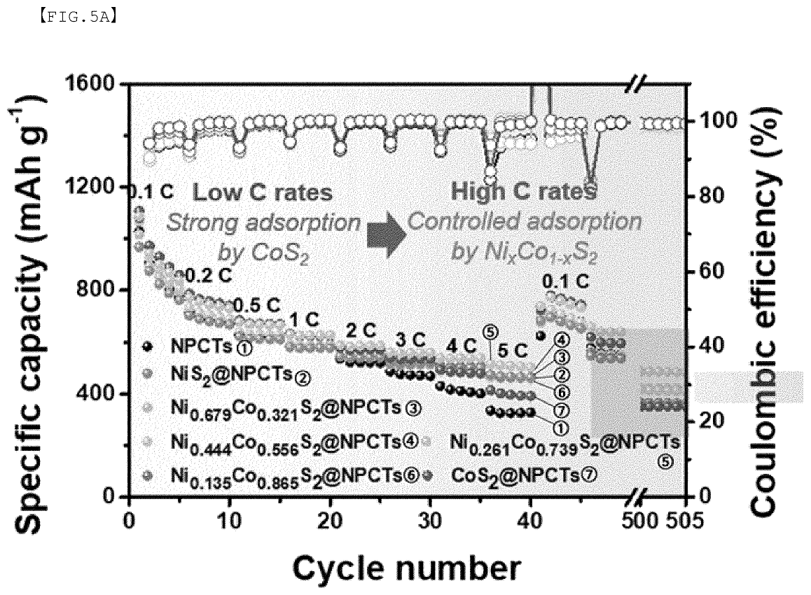

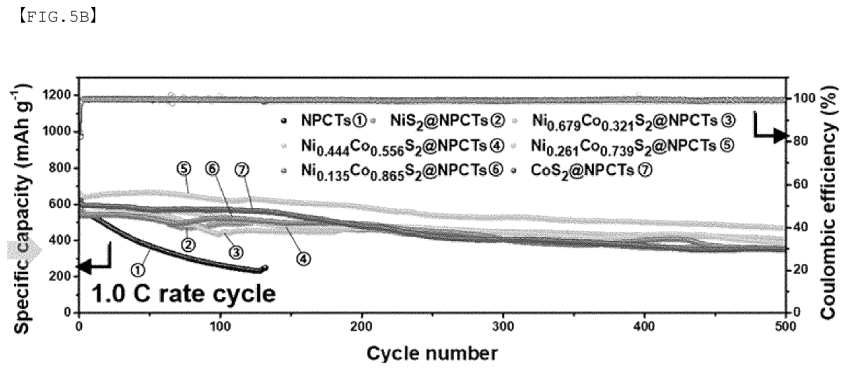

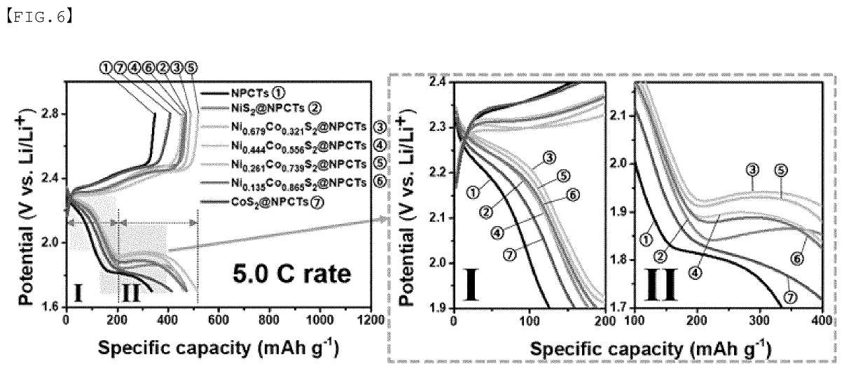

To investigate the electrocatalytic effect derived from the interaction with LiPSs in the adsorption layer of the positive electrode catalyst, the capacity and the cycle performance according to the charging and discharging rate were evaluated in a case where a positive electrode containing an electrocatalyst was used (FIG. 5A and FIG. 5B). The positive electrode containing only sulfur showed the lowest discharge capacity and showed a significantly improved discharge capacity in a case of containing a NPCT host not having a sulfide catalyst; however, it still showed a low discharge capacity.

In a case of NiS₂@NPCTs and CoS₂@NPCTs, it was found that although NiS₂@NPCTs show a low capacity as compared with CoS₂@NPCTs at a low rate (0.1 to 3.0 C), NiS₂@NPCTs show a high capacity at a high rate (4.0 to 5.0 C).

The catalyst of CoS₂@NPCTs showed a high discharge capacity as compared with NiS₂@NPCTs at a low charging and discharging rate (0.1 to 3.0 C), which may be due to the fact that the shuttling effect was suppressed through a stronger interaction with LiPSs and thus the time for maintaining the stepwise conversion reaction was lengthened (FIG. 5A). However, too strong interaction through the excessive adsorption of LiPSs may rather inhibit the complete sulfur oxidation-reduction cycle of the general Li—S battery, and thus it is necessary to control the binding energy in order to enable rapid electron transfer and overcome the limitations of catalytic function.

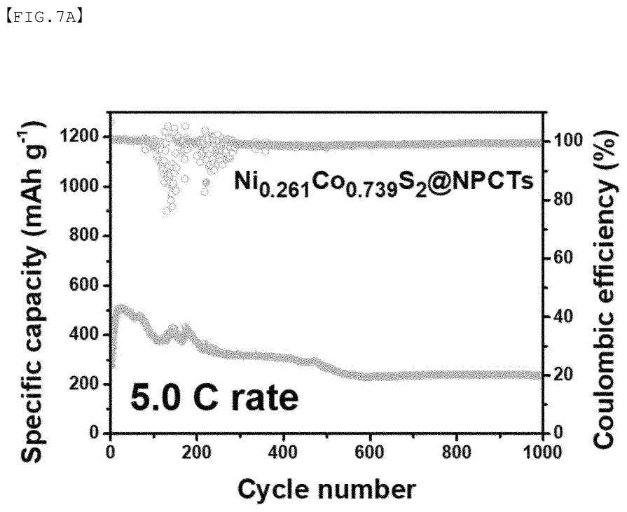

The cycling performance at 1.0 C is such that the best performance is shown in Ni_{0.261}Co_{0.739}S₂@NPCTs, where the highest cycle stability having a retention rate of 72.8% is shown with a capacity reduction of 0.054% per cycle (FIG. 5B). NiS₂@NPCTs showed a retention rate of 66.5% per cycle and a capacity loss rate of 0.067% per cycle, and the positive electrodes of Ni_{0.679}Co_{0.321}S₂@NPCTs and Ni_{0.444}Co_{0.556}S₂@NPCTs, which are engineered with Coₒₕ²⁺, showed 69.0% and 69.5% with a loss rate of capacity 0.062% and 0.061%, respectively, suggesting that the catalytic NiₓCo₁₋ₓS₂ can act as an effective LiPSs immobilizer that minimizes the shuttle effect. After that, the kinetics improved by using the positive electrode catalyst of Ni_{0.261}Co_{0.739}S₂@NPCTs could be verified through a constant current charging and discharging profile obtained at a specific current rate (FIG. 6). FIG. 6 shows the overvoltage reduced due to the performance of Ni_{0.261}Co_{0.739}S₂@NPCTs.

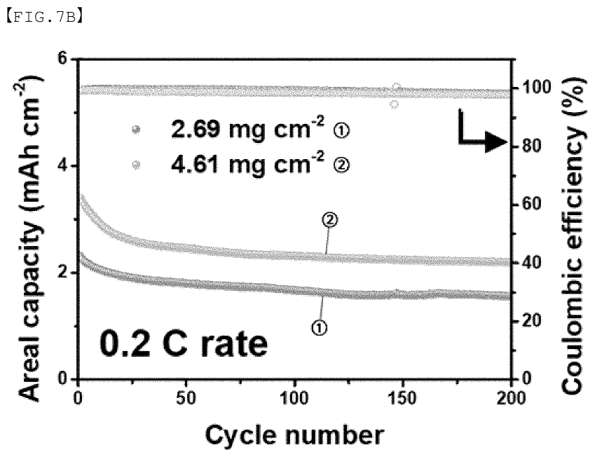

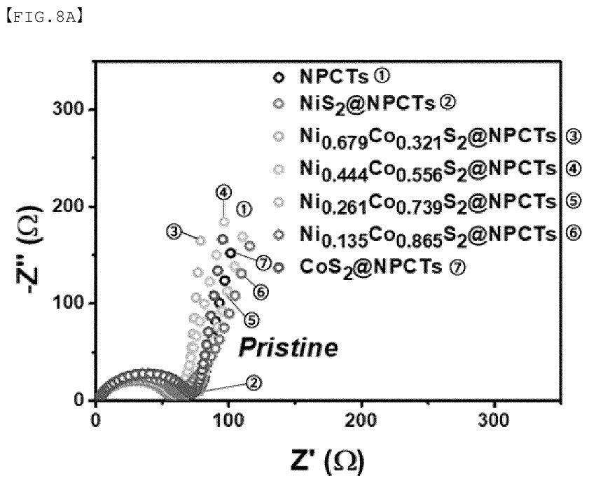

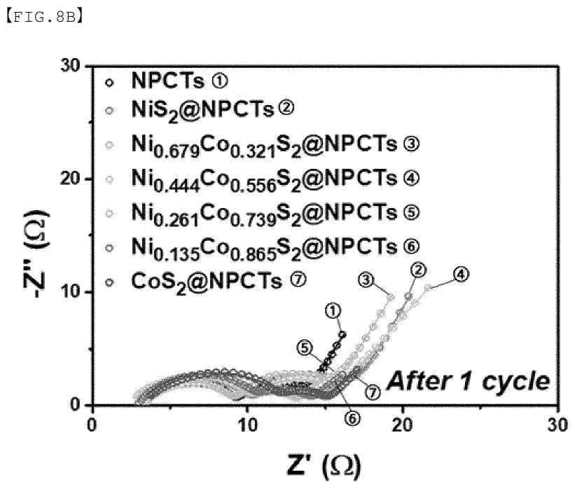

FIG. 7A shows that a large capacity of up to a maximum of 511 mAh/g is exhibited even in a case where the current rate of the lithium-sulfur battery using the Ni_{0.261}Co_{0.739}S₂@NPCTs catalyst was largely increased to 5.0 C, and a low rate of a capacity reduction of 0.055% on average per cycle even after 1,000 cycles. In addition, a high discharge capacity of 2.20 mAh/cm² was still exhibited even in a case where the sulfur as an active material used in the positive electrode was adjusted to 4.61 mg/cm², which is a high loading amount required by industrial standards, and then the cycle was carried out a total of 200 times at a current rate of 0.2 C.

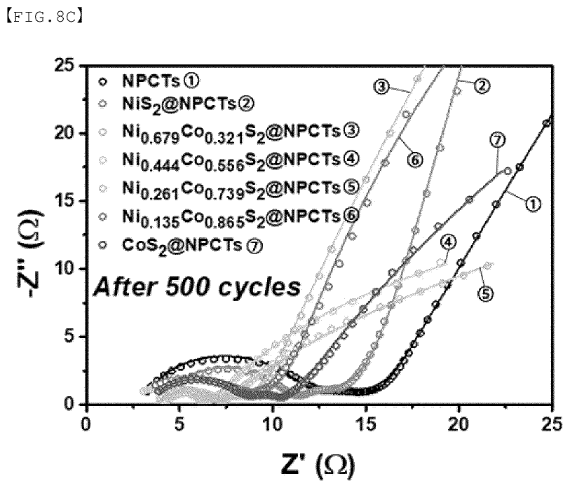

FIG. 8A, FIG. 8B and FIG. 8C show the results obtained by analyzing an electrochemical impedance spectroscopy Nyquist plot. It was confirmed that both the charge transfer resistance and the electrolyte/electrode interface resistance for the Ni_{0.261}Co_{0.739}S₂@NPCTs cell are low. Through this, it could be seen that due to the excellent catalytic activity, the performance is improved due to the low resistance during the charging and discharging process in the cell.

By using the lithium-sulfur battery positive electrode material according to the invention, the shuttle effect during the operation of a lithium-sulfur battery is suppressed, which makes it possible to improve the cycle characteristics of the lithium-sulfur battery.

In addition, by using the manufacturing method for a lithium-sulfur battery positive electrode material according to the invention, a lithium-sulfur battery positive electrode material may be manufactured simply and with high productivity.

In addition, a lithium-sulfur battery to which the lithium-sulfur battery positive electrode material according to the invention is applied may have excellent lifespan characteristics.

What is claimed is:

1. A lithium-sulfur battery positive electrode material comprising:
a nitrogen-doped carbon nanotube; and
sulfur arranged in an inside of said carbon nanotube,
wherein transition metal sulfide nanocrystals are dispersed on a surface of said carbon nanotube.

2. The lithium-sulfur battery positive electrode material according to claim 1,
wherein said transition metal in the transition metal sulfide nanocrystals is nickel and cobalt.

3. The lithium-sulfur battery positive electrode material according to claim 2,
wherein said transition metal sulfide nanocrystal has a composition according to the following [Chemical Formula 1],

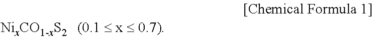

4. The lithium-sulfur battery positive electrode material according to claim 3,
wherein said x is in a range of 0.2≤x≤0.5.

5. A manufacturing method for a lithium-sulfur battery positive electrode material, the manufacturing method comprising:
preparing a nitrogen-doped carbon nanotube;
synthesizing a nickel-thiourea compound and a cobalt-thiourea compound;
adding said nitrogen-doped carbon nanotube to a solvent and dispersing said nitrogen-doped carbon nanotube;
adding said nickel-thiourea compound and said cobalt-thiourea compound to a solvent in which said carbon nanotube is dispersed and carrying out mixing to prepare a mixed slurry;
evaporating the solvent while stirring said mixed slurry, thereby obtaining a solid mixture;
heating the solid mixture to obtain a transition metal sulfide-carbon nanotube composite in which the transition metal sulfide nanocrystal is dispersed and arranged on a surface of the nitrogen-doped carbon nanotube; and
injecting sulfur into an inside of said transition metal sulfide-carbon nanotube composite.

6. The manufacturing method for a lithium-sulfur battery positive electrode material according to claim 5,
wherein the preparing of the nitrogen-doped carbon nanotube comprises:
(a) adding FeCl₃ and sodium dodecylbenzenesulfonate (SDBS) to a methyl orange aqueous solution and carrying out mixing to prepare a mixed aqueous solution;
(b) adding pyrrole dropwise while stirring said mixed aqueous solution;
(c) recovering a precipitate from said mixed aqueous solution to which said pyrrole is added dropwise; and
(d) heating the precipitate to obtain said nitrogen-doped carbon nanotube.

7. The manufacturing method for a lithium-sulfur battery positive electrode material according to claim 5,
wherein said heating of said solid mixture is maintained in a range of 300° C. to 500° C. in an inert gas atmosphere.

8. A lithium-sulfur battery comprising:
the lithium-sulfur battery positive electrode material according to claim 1.

9. A lithium-sulfur battery comprising:
the lithium-sulfur battery positive electrode material according to claim 2.

10. A lithium-sulfur battery comprising:
the lithium-sulfur battery positive electrode material according to claim 3.

11. A lithium-sulfur battery comprising:
the lithium-sulfur battery positive electrode material according to claim 4.
